(19) United States
(12) Patent Application Publication
(10) Pub. No.: US 2004/0052625 A1
(43) Pub. Date: Mar. 18, 2004

(54) Transport trailer having retractable loading ramps and equipment securing system

(76) Inventor: Larry Butterfield, Clay Center, KS (US)

Correspondence Address: Jeffrey L. Thompson, THOMPSON & THOMPSON, P.A., 310 4th Street, P.O. Box 66, Scandia, KS, 66966, US

(21) Appl. No.: 10/313,412

(22) Filed: Dec. 5, 2002

Related U.S. Application Data
(60) Provisional application No. 60/411,186, filed on Sep. 16, 2002.

(51) Int. Cl. B60P 1/43

(52) U.S. Cl. 414/537

(57) ABSTRACT

A transport trailer for transporting large agricultural spray vehicles has a platform supported by a plurality of wheels, and a pair of loading ramps to facilitate loading vehicles onto the platform. An operating mechanism is provided for pivoting the loading ramps between raised and lowered positions, and includes a pneumatic actuator and a J-shaped arm associated with each loading ramp. The trailer is also equipped with a plurality of tie down arms to automatically secure the spray vehicle to the trailer when the loading ramps are raised. A lock mechanism selectively locks the tie-down arms in their respective lowered positions. A sign having visual indicia, such as the words “WIDE LOAD,” is pivotally connected to a rear end of the trailer platform. The sign is interconnected with the operating mechanism for the loading ramps to pivot the sign between lowered and raised positions upon corresponding movement of the loading ramps.

### RELATED APPLICATIONS

The Applicant claims priority under 35 U.S.C. §119(e) of provisional U.S. Patent Application Serial No. 60/411,186 filed on Sep. 16, 2002.

### BACKGROUND OF THE INVENTION

1. Field of the Invention

The present invention relates generally to wheeled vehicles and transport trailers. In particular, the present invention relates to transport trailers for carrying large agricultural and commercial vehicles, such as spray vehicles, that must be loaded and unloaded frequently.

2. Description of the Related Art

Heavy farm and industrial equipment and commercial vehicles are often transported using trailers having special loading ramps at the rear end of the trailers to facilitate loading and unloading. During the use of such trailers, a persistent problem has been the difficult and time-consuming task of moving the loading ramps between their raised transport positions and their lowered positions for loading and unloading. This is particularly so in the case of agricultural spray vehicles and the like that must be loaded and unloaded frequently.

For example, large agricultural spray vehicles are commonly used to spray many different fields in remote locations during a single day. At each field location, the loading ramps must be pivoted from their raised positions into their lowered positions to allow the spray vehicle to roll smoothly off the rear end of the trailer onto the ground. After spraying each field, the spray vehicle must then be driven back up the ramps and onto the trailer. Once the vehicle is on the trailer, the ramps must be pivoted back into their raised position and secured in place. The vehicle itself must then be secured to the trailer using cables or chains and suitable tightener devises. In many cases, a “WIDE LOAD” warning sign is also secured into place at the rear of the trailer for highway transport. The trailer, with the spray vehicle secured thereon, is then ready to move to the next field location where the unloading, spraying, and reloading process is repeated.

Various improvements have been proposed to make transport trailers easier to load and unload. For example, U.S. Pat. No. 4,136,791 issued to Clark discloses a transport trailer having a tiltable loading ramp that can be moved between an inclined loading position and a horizontal transport position using a pair of hydraulic rams. U.S. Pat. No. 4,792,274 issued to Cockram discloses a utility trailer having an automatic tailgate assembly that moves from an inclined loading position into a tailgate forming position when the item to be transported contacts a front trigger plate assembly. U.S. Pat. No. 4,372,727 issued to Fredrickson et al. discloses a transport trailer having a powered ramp tail movable in multiple stages between an inclined loading position and a horizontal transport position using hydraulic actuators. U.S. Pat. No. 6,126,223 issued to Rayburn discloses a transport trailer having a tailgate lift assembly that uses a spring-biased cable to raise the tailgate from an inclined loading position into a raised transport position. U.S. Pat. No. 5,145,310 issued to Calzone discloses a reverse spring system to facilitate moving trailer ramps from a transport position into a loading position.

The prior art patents described above provide various systems to facilitate the raising and lowering of loading ramps or tailgates of transport trailers. However, none of these systems include a tie-down mechanism associated with the loading ramps to secure the vehicle being transported to the trailer. These systems also lack a “WIDE LOAD” warning sign that automatically moves between lowered and raised positions with the movement of the loading ramps. Thus, additional time-consuming steps must be taken to secure the vehicle to the trailer using chains or cables and suitable tightening mechanisms, and also to mount a “WIDE LOAD” warning sign behind the trailer after it is loaded. This leads to greater operator fatigue and less productivity for the vehicle and other equipment being transported on the trailer. The prior art systems also lack a structure to stabilize the rear end of the trailer when the loading ramps are in their lowered positions and the vehicle is being loaded and unloaded.

### SUMMARY OF THE INVENTION

An object of the present invention is to provide a transport trailer having retractable loading ramps and an equipment securing system that are interconnected for more efficient and effective loading and unloading operations.

A further object of the present invention is to provide a transport trailer having a “WIDE LOAD” warning sign that automatically moves between lowered and raised positions upon moving the loading ramps of the trailer between their lowered and raised positions.

It is a further object of the present invention to provide an improved ramp assembly for a transport trailer that can be moved easily between an inclined lowered position and a raised transport position to facilitate frequent loading and unloading operations.

It is a further object of the present invention to provide an equipment securing system having a locking structure that can be engaged automatically to maintain a secure attachment of the equipment securing system to the vehicle being carried by the trailer.

It is a further object of the present invention to provide a transport trailer that can be loaded and unloaded frequently and quickly with little effort, that includes an equipment securing system to facilitate attaching items to the trailer, that automatically displays a “WIDE LOAD” warning sign at the rear end of the trailer after a wide load is positioned on the trailer, and that includes a structure for stabilizing the rear end of the trailer during loading and unloading.

It is a further object of the present invention to provide a transport trailer that is economical to manufacture, efficient in use, capable of a long operating life, and particularly well suited for use in transporting large agricultural spray vehicles and the like.

To accomplish these and other objects, a transport trailer for transporting agricultural vehicles is provided by the present invention. The transport trailer has a platform supported by a plurality of wheels, and a pair of loading ramps to facilitate loading vehicles onto the platform. An operating mechanism is provided for pivoting the loading ramps between raised and lowered positions. The operating mechanism includes an actuator and a J-shaped arm associated with each loading ramp. The J-shaped arm provides a structure for stabilizing the rear end of the trailer during loading and unloading.

According to the present invention, the trailer is also equipped with a plurality of tie down arms to automatically secure the spray vehicle to the trailer when the loading ramps are raised. The operating mechanism that raises and lowers the loading ramps is also used to move the tie down arms. A lock mechanism selectively locks the tie-down arms in their respective lowered positions.

The transport trailer of the present invention also includes a sign having visual indicia, such as the words “WIDE LOAD,” pivotally connected to a rear end of the trailer platform. The sign is interconnected with the operating mechanism that raises and lowers the loading ramps to pivot the sign between lowered and raised positions upon corresponding movement of the loading ramps.

Numerous other objects and advantages of the present invention will be apparent to those skilled in this art from the following description wherein there is shown and described a preferred embodiment of the present invention, simply by way of illustration of one of the modes best suited to carry out the invention. As will be realized, the invention is capable of other different embodiments, and its several details are capable of modification in various obvious aspects without departing from the invention. Accordingly, the drawings and description should be regarded as illustrative in nature and not restrictive.

### BRIEF DESCRIPTION OF THE DRAWINGS

The present invention will become more clearly appreciated as the disclosure of the invention is made with reference to the accompanying drawings. In the drawings:

FIG. 1 is an elevation view of a transport trailer according to the present invention with a large spray vehicle carried thereon.

FIG. 2 is an elevation view of the transport trailer shown in FIG. 1 with the vehicle in the process of being loaded or unloaded.

FIG. 3 is a plan view of a rear portion of the transport trailer according to the present invention with one loading ramp shown in a lowered position for loading and unloading, and the other ramp shown in a raised position.

FIG. 4 is a side view of one of the loading ramps and a ramp operating mechanism with the ramp in a raised position according to the present invention.

FIG. 5 is a side view of the loading ramp and ramp operating mechanism shown in FIG. 4 with the ramp in a lowered position according to the present invention.

FIG. 6 is a rear view of the transport trailer according to the present invention with the loading ramps and warning sign in raised positions.

FIG. 7 is a rear view of the transport trailer according to the present invention with the loading ramps and warning sign in lowered positions.

FIG. 8 is a front view of a locking mechanism for a tie down system that secures the vehicle on the transport trailer, with the tie down system shown in a locked position.

FIG. 9 is a front view of the locking mechanism of FIG. 8 showing the tie down system in an unlocked position.

FIG. 10 is a perspective view of the operating mechanism for the loading ramps and the tie down system.

### DETAILED DESCRIPTION OF THE PREFERRED EMBODIMENT

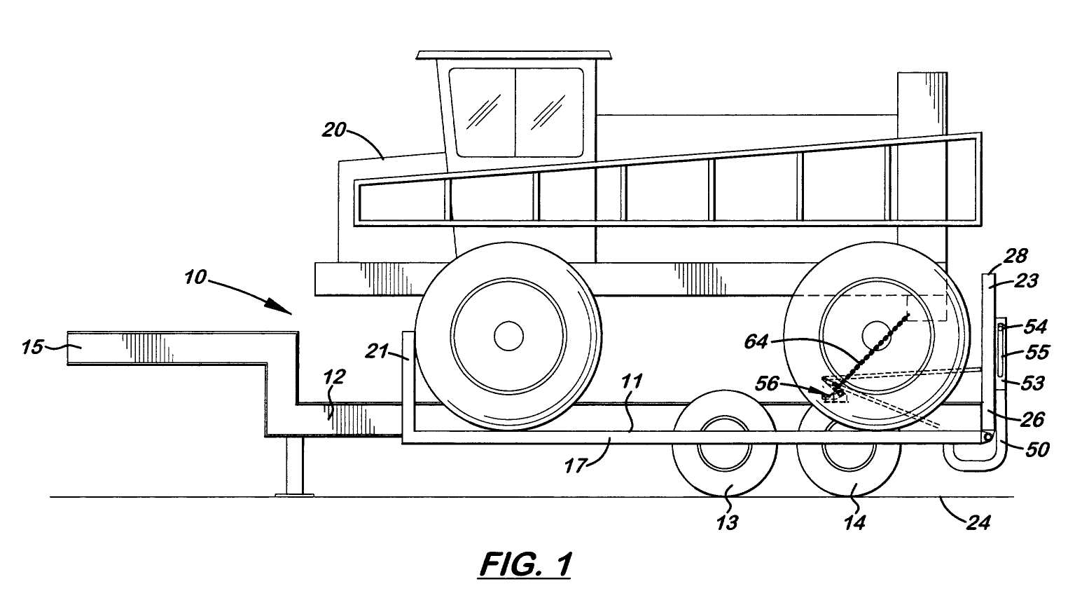

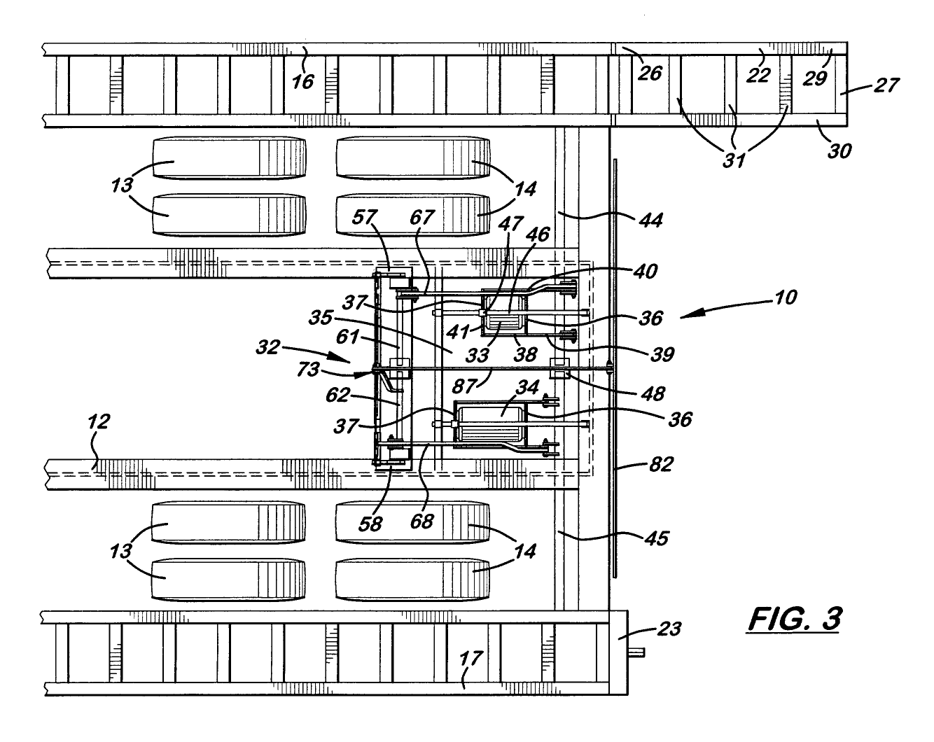

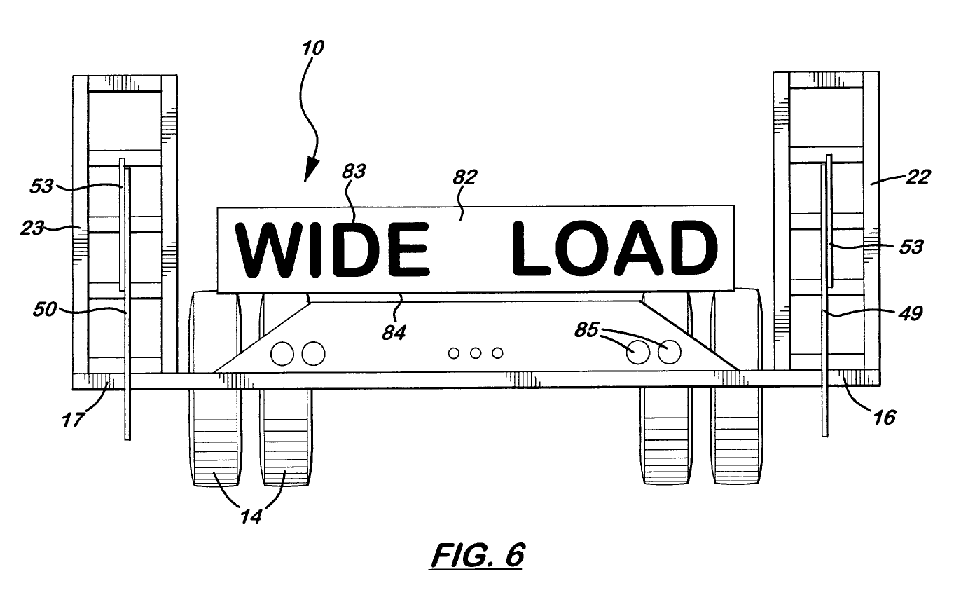

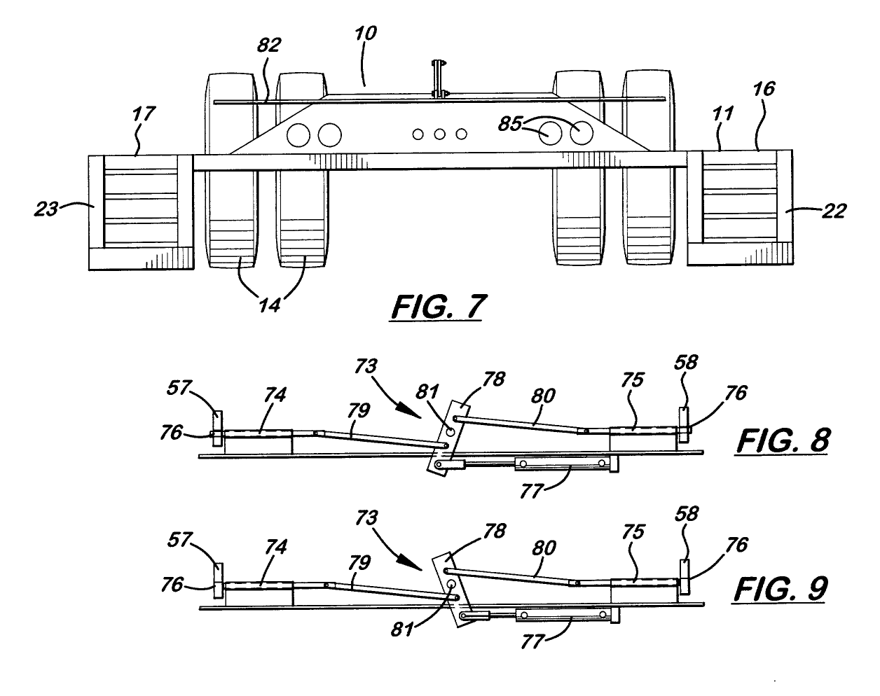

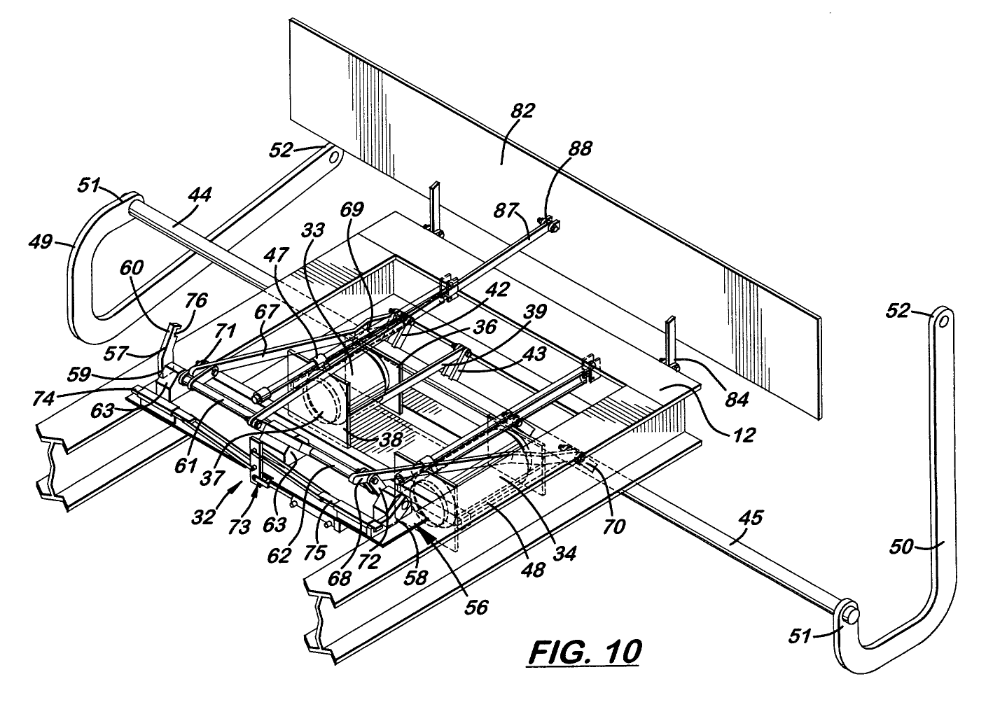

A transport trailer 10 having retractable loading ramps and an equipment securing system according to a preferred embodiment of the present invention will now be described with reference to FIGS. 1 to 10 of the accompanying drawings.

The transport trailer 10 includes a platform 11 supported by a chassis 12 and a plurality of wheels 13, 14. A conventional hitch structure 15 is provided at a front side of the trailer 10 for connection to a truck or the like. The platform 11 has right and left side loading areas 16, 17 for supporting respective right and left side wheels 18, 19 of a large agricultural spray vehicle 20 or other large implement. A front abutment 21 is provided at the front of each of the right and left side loading areas 16, 17 to limit forward movement of the vehicle 20 on the trailer 10.

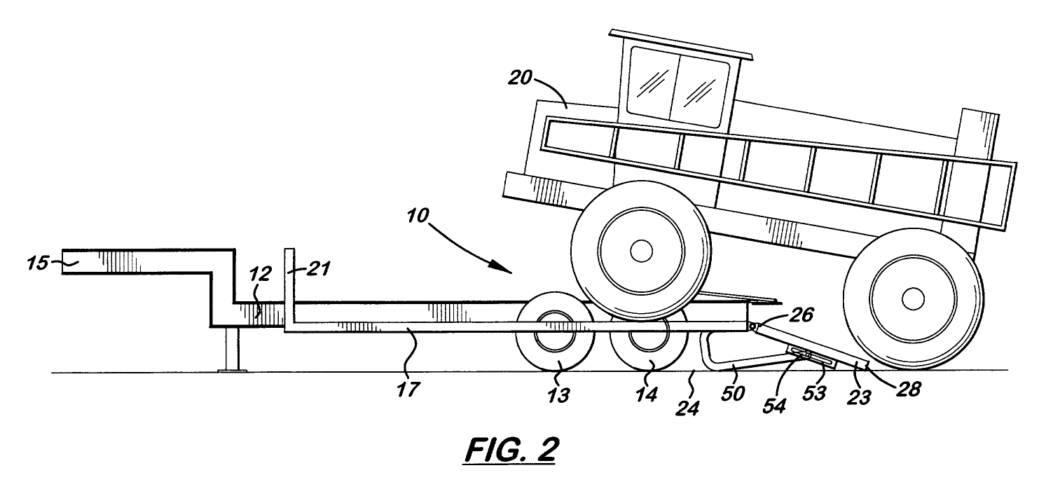

Right and left side loading ramps 22, 23 are provided at the rear of the trailer 10 for facilitating movement of the spray vehicle 20 from the ground surface 24 onto the loading areas 16, 17 of the trailer 10. The loading ramps 22, 23 each have first ends 25, 26 pivotally connected to a rear portion of the loading areas 16, 17 of the trailer 10, and second ends 27, 28 that can be moved into and out of engagement with the ground surface 24. Each loading ramp 22, 23 is movable between a first lowered position (FIGS. 2, 5 and 7) for loading and unloading the vehicle 20, and a second raised position (FIGS. 1, 4 and 6) for transporting the vehicle 20.

In the preferred embodiment, the loading ramps 22, 23 are each constructed of a pair of frame members 29, 30 extending in the longitudinal direction, and a plurality of transverse members 31 attached between the frame members 29, 30. However, a variety of other construction techniques for the loading ramps 22, 23 are also possible and within the scope of the present invention.

An operating mechanism 32 is provided for pivoting the loading ramps 22, 23 between their respective lowered and raised positions. The operating mechanism 32 includes a pair of linear actuators 33, 34 arranged in a center console 35 of the trailer 10. In the preferred embodiment, the linear actuators 33, 34 are pneumatic bladder-type actuators (i.e., air bags) which are placed on their sides to expand and retract in a longitudinal direction of the trailer 10. The linear actuators 33, 34 each have a first end 36 secured to a stationary part of the trailer 10, such as the frame or chassis 12, and a second end 37 connected to a moving bracket 38. The moving brackets 38 each include a pair of arms 39, 40 that extend rearwardly from a front plate 41 and connect to radial extending arms 42, 43 on a respective transverse shaft 44, 45. The front plate 41 of each moving bracket 38 is slidably supported on a support shaft 46 using a short tubular member 47 placed over the support shaft 46. Tension springs 48 are used to bias the linear actuators 33, 34 to their retracted positions.

The transverse shafts 44, 45 are pivoted independently of each other upon extending and retracting the respective linear actuators 33, 34. Shock absorbers (not shown) or other damping mechanisms can be used in conjunction with the linear actuators 33, 34 to restrict the speed of movement of the actuators 33, 34, although in most applications this will not be necessary. The transverse shafts 44, 45 are supported at each end to the frame of the trailer 10 by bearings 48.

The operating mechanism 32 also includes a pair of J-shaped arms 49, 50 associated with the loading ramps 22, 23. The J-shaped arms 49, 50 each have a first end 51 rigidly connected to a respective one of the transverse shafts 44, 45, e.g., by welding, and a second end 52 pivotally and slidably coupled to a respective one of the loading ramps 22, 23. The J-shaped arms 49, 50 are driven by rotation of the transverse shafts 44, 45 to move the loading ramps 22, 23 between their lowered and raised positions. The J-shaped arms 49, 50 are arranged so that they rest on the ground surface 24 and help stabilize the rear end of the trailer 10 when the loading ramps 22, 23 are in their down positions, as shown in FIG. 2.

The second ends 52 of the J-shaped arms 49, 50 are pivotally and slidably coupled to slotted members 53 that are attached to and extend along the bottom sides of the loading ramps 22, 23. Pin connectors 54 extend through holes formed in the second ends 52 of the J-shaped arms 49, 50 and into or through the slots 55 formed in the slotted members 53. When the J-shaped arms 49, 50 are moved by the transverse shafts 44, 45, the pin connectors 54 pivot and slide along the slots 55 in the slotted members 53. Other construction techniques for pivotally and slidably connecting the J-shaped arms 49, 50 to the loading ramps 22, 23 can also be used, such as using grooved members or tracks instead of a slotted member.

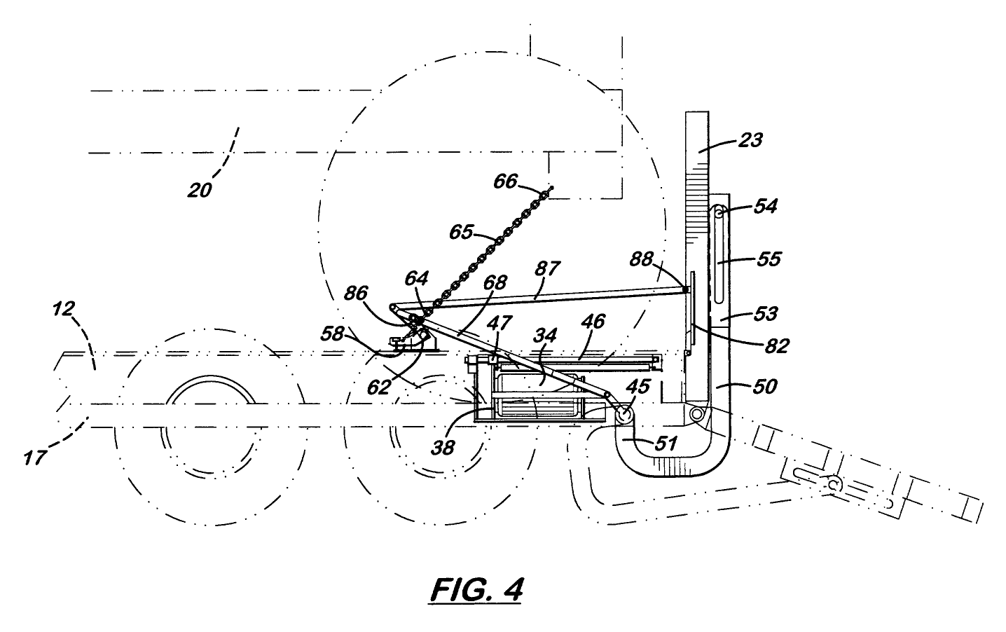

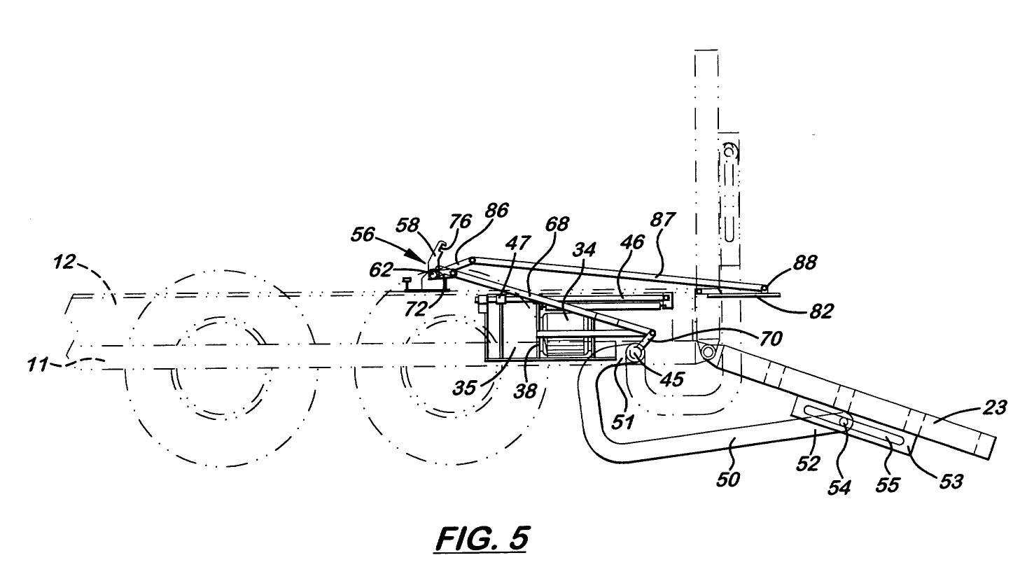

The trailer 10 has a tie-down mechanism 56 to facilitate securing the spray vehicle 20 to the trailer 10. The tie-down mechanism 56 includes right and left side tie down arms 57, 58 each having first and second ends 59, 60. The first ends 59 of each of the tie down arms 57, 58 are rigidly attached, e.g., by welding, to respective right and left transverse shafts 61, 62. The transverse shafts 61, 62 are supported at each end by bearings 63 and can be rotated independently of each other. The second ends 60 of each of the tie down arms 57, 58 are provided with a loop, hole, hook or other suitable structure for coupling with a flexible connector 64, such as a link chain. The tie down arms 57, 58 are movable between a first raised position (FIG. 5) and a second lowered position (FIG. 4) by rotation of the respective transverse shafts 61, 62.

The flexible connector 64 has one end 65 attached to the tie down arms 57, 58 and another end 66 adapted to be attached to a frame or chassis of the vehicle 20 loaded on the trailer 10. For example, the vehicle 20 can be provided with a slot into which a chain link of the flexible connector 64 can be placed and securely held. When the tie down arms 57, 58 are in their raised positions, the flexible connector 64 is loose and can be easily attached or removed from the vehicle. When the tie down arms 57, 58 are in their lowered positions, the flexible connector 64 is tightened and kept taut to secure the vehicle 20 to the trailer 10.

The tie down mechanism 56 is operatively interconnected with the operating mechanism 32 of the loading ramps 22, 23 so that movement of the tie down arms 57, 58 is synchronized with movement of the loading ramps 22, 23. Tie down actuator links 67, 68 are connected to radial extending arms 69, 70 on the first transverse shafts 44, 45 and extend forwardly to operate the tie down mechanism 56. Radial arm assemblies 71, 72 are connected to each of the second transverse shafts 61, 62 and are pivotally connected to the front ends of the tie down actuator links 67, 68. When the linear actuators 33, 34 are expanded or contracted to rotate the first set of transverse shafts 44, 45, the tie down actuator links 67, 68 transmit the driving force to the second transverse shafts 61, 62. As a result, the tie down arms 57, 58 move from their raised positions to their lowered positions when the loading ramps 22, 23 move from their lowered positions to their raised positions, respectively. The right side tie down arm 57 moves in sync with the right side loading ramp 22, and the left side tie down arm 58 moves in sync with the left side loading ramp 23.

A lock mechanism 73 is provided to positively lock the tie down arms 57, 58 in their lowered positions for maintaining the flexible connectors 64 in a taut condition. The lock mechanism 73 has right and left side lock members 74, 75 that can be inserted into recesses 76 in the tie down arms 57, 58 when the tie down arms 57, 58 are in their lowered positions. The lock mechanism 73 includes a linear actuator 77 that automatically moves the lock members 74, 75 into their locked positions after the tie-down arms 57, 58 are moved into their lowered positions.

The linear actuator 77 is operatively connected to the lock members 74, 75 by a toggle arm 78 and linkage assemblies 79, 80. The toggle arm 78 is pivotally attached at a midpoint 81 to a bearing housing 82 or other part of the trailer 10. The linear actuator 77 is connected to a lower end of the toggle arm 78 for pivoting the toggle arm 78 about its midpoint 81. When the linear actuator 77 is extended, the toggle arm 78 is pivoted clockwise to cause the sliding lock members 74, 75 to engage and lock the tie-down arms 57, 58 in their lowered positions.

In the preferred embodiment, the first and second linear actuators 33, 34 and the linear actuator 77 are connected in a common pneumatic or hydraulic circuit. The linear actuator 77 operates sequentially with the linear actuators 33, 34 to move the lock members 74, 75 into their locked positions following movement of the tie-down arms 57, 58 into their lowered positions. Similarly, the linear actuator 77 operates to move the lock members 74, 75 into their unlocked positions before the tie-down arms 57, 58 are moved from their lowered positions to their raised positions.

A sign 82 having visual indicia 83 thereon, such as a “WIDE LOAD” or “OVERSIZE LOAD” warning, is attached to a rear end of the trailer 10. The sign 82 is pivotally connected along its lower edge 84 to the rear end of the trailer 10 for pivoting movement between lowered and raised positions. In the raised position (shown in FIGS. 1,6 and 10), the sign 82 is readily visible to other vehicles following the trailer 10 and does not impede the view of the tail lights 85 of the trailer 10. However, the sign 82 cannot remain in its raised position while the vehicle 20 is being loaded and unloaded because it blocks the path of the vehicle 20 onto the trailer 10. By pivoting the sign 82 to its lowered position during loading and unloading, the sign 82 does not block the path of the vehicle 20 onto the trailer 10.

The sign 82 is interconnected with the operating mechanism 32 such that the sign 82 pivots between its lowered and raised positions upon movement of one of the loading ramps 23 between its lowered and raised positions. A center radial arm 86 extends from one of the transverse shafts 45 for driving the sign 82. A link 87 is pivotally connected to the center radial arm 86 and extends rearward to a bracket 88 on a back side of the sign 82. The center radial arm 86 moves the link 87, and hence, the sign 82, when the transverse shaft 45 is rotated by the operating mechanism 32.

While the invention has been specifically described in connection with specific embodiments thereof, it is to be understood that this is by way of illustration and not of limitation, and the scope of the appended claims should be construed as broadly as the prior art will permit.

What is claimed is:

1. A transport trailer for transporting agricultural vehicles, comprising:
a platform supported by a plurality of wheels;
at least one loading ramp having a first end pivotally connected to a rear end of the trailer about a first pivot axis;
at least one tie down arm having a structure for securing the vehicle to the trailer, said tie down arm being arranged for swinging movement about a second pivot axis; and
an operating mechanism for moving the loading ramp about said first pivot axis and for moving the tie down arm about said second pivot axis, said loading ramp being movable about said first pivot axis between a first lowered position for loading and unloading and a second raised position for transport, and said tie down arm being movable about said second pivot axis between a first position in which said structure for securing the vehicle to the trailer can be easily attached and removed from the vehicle, and a second position in which said structure is tightened and kept taut to secure the vehicle to the trailer.

2. The transport trailer according to claim 1, wherein said at least one loading ramp comprises a right-side loading ramp and a left-side loading ramp, and each of said loading ramps is pivotally connected to the rear end of the trailer for movement about respective transverse axes.

3. The transport trailer according to claim 1, wherein said at least one tie down arm comprises a right-side tie down arm and a left-side tie down arm, and said structure for securing the vehicle to the trailer comprises flexible connecting members attached to respective free ends of the tie down arms.

4. The transport trailer according to claim 1, wherein said operating mechanism includes a J-shaped arm having a first end connected to a transverse shaft and a second end connected to said loading ramp at a location spaced from said first pivot axis, said J-shaped arm being driven by said transverse shaft to move said loading ramp between its first and second positions.

5. The transport trailer according to claim 4, wherein said first end of the J-shaped arm is rigidly connected to said transverse shaft to rotate with said transverse shaft, and a second end of the J-shaped arm is pivotally and slidably connected to a lower side of said loading ramp.

6. The transport trailer according to claim 5, wherein said J-shaped arm is arranged to rest on the ground and help stabilize a rear end of the trailer when the loading ramp is in its first lowered position.

7. The transport trailer according to claim 1, further comprising a lock mechanism having a lock member that positively locks the tie-down arm in its second position for maintaining the structure for securing the vehicle to the trailer in a taut condition.

8. The transport trailer according to claim 1, wherein said operating mechanism comprises a first transverse shaft supported for rotation about a transverse axis, a radial arm fixed to the first transverse shaft and extending outwardly therefrom, a first linear actuator having a first end fixed to a stationary part of the trailer and a second end pivotally connected to said radial arm such that said first transverse shaft is rotated upon linear movement of said first linear actuator, and a member connecting said first transverse shaft to said loading ramp such that said loading ramp is moved between its first and second positions upon rotation of said first transverse shaft.

9. The transport trailer according to claim 8, wherein said operating mechanism further comprises a first link member operably connected between said first transverse shaft and a second transverse shaft, said second transverse shaft being rotatably driven by rotation of said first transverse shaft, said tie down arm being fixed to and extending from said second transverse shaft, whereby said tie down arm is movable between its first and second positions upon linear movement of said first linear actuator.

10. The transport trailer according to claim 9, further comprising a sign having visual indicia thereon which is pivotally mounted to the rear end of the trailer and movable between raised and lowered positions, and a second link member which is pivotally connected at a first end to said sign and operably connected at a second end to said first linear actuator, wherein said sign is movable between its raised and lowered positions upon moving said loading ramp between its raised and lowered positions.

11. The transport trailer according to claim 10, wherein said second link member is pivotally connected at its second end to an actuator arm which extends radially from said second transverse shaft, whereby said sign is movable between its raised and lowered positions as a result of pivoting movement of said second transverse shaft.

12. The transport trailer according to claim 9, further comprising a lock mechanism having a lock member that positively locks the tie-down arm in its second position, and a second linear actuator for moving said lock member between engaged and disengaged positions relative to the tie-down arm, said first and second linear actuators being connected in a common circuit such that said second linear actuator operates sequentially with the first linear actuator to move said lock member into its locked position following movement of the tie-down arm into its second position, and to move said lock member into its unlocked position before the tie-down arm is moved from its second position to its first position.

13. The transport trailer according to claim 8, wherein said first linear actuator comprises a pneumatic bladder-type actuator.

14. The transport trailer according to claim 13, wherein said first linear actuator is arranged to extend and retract in a longitudinal direction of the trailer.

15. A wheeled transport trailer for transporting large implements, comprising:
a platform supported by a plurality of wheels, said platform having right and left side loading areas for supporting respective right and left sides of an implement;
right and left side loading ramps for facilitating movement of an implement from a ground surface onto the right and left side loading areas of the platform, said loading ramps having first ends pivotally connected to the platform, each loading ramp being movable between a first lowered position for loading and unloading and a second raised position for transport; and
an operating mechanism for pivoting the right and left side loading ramps between their respective lowered and raised positions.

16. The wheeled transport trailer according to claim 15, further comprising right and left side tie down arms each having a structure to facilitate securing the implement to the platform, said tie down arms being interconnected with the operating mechanism such that said tie down arms pivot between raised and lowered positions upon movement of said loading ramps between lowered and raised positions.

17. The wheeled transport trailer according to claim 16, further comprising a lock mechanism having right and left side lock members that positively lock the right and left side tie-down arms in their respective lowered positions, said lock mechanism having an actuator that automatically moves the lock members into a locked position after the tie-down arms are moved into their lowered positions.

18. The wheeled transport trailer according to claim 15, further comprising a sign having visual indicia thereon, said sign being pivotally connected to a rear end of the platform for movement between lowered and raised positions, said sign being interconnected with the operating mechanism such that said sign pivots between its lowered and raised positions upon movement of said loading ramps between their lowered and raised positions.

19. The wheeled transport trailer according to claim 15, wherein said operating mechanism comprises right and left side J-shaped arms having first ends rigidly connected to respective right and left side transverse shafts and second ends pivotally and slidably connected to the right and left side loading ramps, respectively, said J-shaped arms being driven by rotation of the transverse shafts to move said loading ramps between said lowered and raised positions.

20. The wheeled transport trailer according to claim 15, wherein said J-shaped arms are arranged to rest on the ground and help stabilize a rear end of the trailer when the loading ramps are in their lowered positions.
